(19) United States
(12) Patent Application Publication
(10) Pub. No.: US 2019/0236545 A1
(43) Pub. Date: Aug. 1, 2019

(54) ORDER QUANTITY DETERMINATION SYSTEM, ORDER QUANTITY DETERMINATION METHOD, AND ORDER QUANTITY DETERMINATION PROGRAM

(71) Applicant: NEC Corporation, Minato-ku, Tokyo (JP)

(72) Inventors: Keisuke UMEZU, Tokyo (JP); Yuuki KUBOTA, Tokyo (JP); Takayuki NAKANO, Tokyo (JP)

(73) Assignee: NEC Corporation, Minato-ku, Tokyo (JP)

(21) Appl. No.: 16/330,123

(22) PCT Filed: Jul. 25, 2017
(86) PCT No.: PCT/JP2017/026841

§ 371 Date: Mar. 4, 2019

(30) Foreign Application Priority Data
Sep. 5, 2016 (JP) 2016-172529

(51) Int. Cl. G06Q 10/08; G06Q 30/02

(52) U.S. Cl. CPC G06Q 10/0875; G06Q 30/0202

(57) ABSTRACT

Error calculation means 81 calculates an error in a demand quantity predicted by a prediction model, and, from a predicted demand quantity during a covered time slot and a predicted demand quantity during a sales permitted period calculated for each product, calculates an error in the predicted demand quantity during the covered time slot and an error in the predicted demand quantity during the sales permitted period. Safety stock quantity calculation means 82 calculates an occurrence probability of the predicted demand quantity during the covered time slot, for each product, and an occurrence probability of the predicted demand quantity during the sales permitted period, for each product, from the errors and calculates a safety stock quantity. Order quantity calculation means 83 calculates an order quantity, from a stock quantity anticipated at a time point of delivery, the predicted demand quantity during the covered time slot, and the safety stock quantity.

### TECHNICAL FIELD

The present invention relates to an order quantity determination system, an order quantity determination method, and an order quantity determination program which determine order quantities of products.

### BACKGROUND ART

Various methods for appropriately determining the order quantities of products to reduce unnecessary stock or out-of-stock condition have been proposed. For example, Patent Literature (PTL) 1 describes an inventory management system which, when goods are delivered or ordered periodically, determines the order quantity of the goods with higher accuracy. The system described in PTL 1 predicts the demand within a target prediction period which is a period from a time point of delivery in response to ordering to a time point of next delivery.

Further, the system described in PTL 1 calculates a prediction-error-addressing safety stock for absorbing a difference between the predicted demand quantity and the actual demand quantity to address the prediction error, and then calculates the order quantity, taking account of delivery delay as well, as follows: order quantity=predicted demand quantity−stock on hand−stock on order+(prediction-error-addressing safety stock+delivery-delay-addressing safety stock).

### CITATION LIST

### Patent Literature

PTL 1: Japanese Patent Application Laid-Open No. 2009-187151

### SUMMARY OF INVENTION

### Technical Problem

In the system described in PTL 1, the safety stock quantity is determined on the basis of an actual prediction error in the past, calculated from the difference between the actual demand quantity and the predicted demand quantity. However, when the error is calculated on the basis of the actual demand quantity and the predicted demand quantity, the error may include, not only the error of the prediction itself, but also an error due to a factor unanticipated at the time of prediction (such as, for example, an unexpected event).

Further, the system described in PTL 1 determines the safety stock on the basis of a predetermined service rate, safety factor, and the like when the distribution of actual predicting errors follows the normal distribution. It is preferable from the standpoint of sales that opportunity loss and abandonment loss are both restricted low. However, with the method described in PTL 1, the safety stock value would vary depending on the setting of the service rate, so it is hard to say that the opportunity loss and the abandonment loss are both restricted low.

In view of the foregoing, an object of the present invention is to provide an order quantity determination system, an order quantity determination method, and an order quantity determination program which are capable of determining the order quantity in such a way as to reduce both the opportunity loss and the abandonment loss.

### Solution to Problem

An order quantity determination system according to the present invention includes: error calculation means which calculates an error in a demand quantity predicted by a prediction model, the prediction model predicting demand quantities of products, on the basis of a difference between a predicted demand quantity calculated using the prediction model and past result data that was not used in learning of the prediction model, and, from a predicted demand quantity during a covered time slot representing a delivery interval and a predicted demand quantity during a sales permitted period representing a period until abandonment, which are calculated for each product using the prediction model, calculates an error in the predicted demand quantity during the covered time slot and an error in the predicted demand quantity during the sales permitted period; safety stock quantity calculation means which calculates an occurrence probability of the predicted demand quantity during the covered time slot, for each product, from the error in the predicted demand quantity during the covered time slot, calculates an occurrence probability of the predicted demand quantity during the sales permitted period, for each product, from the error in the predicted demand quantity during the sales permitted period, and calculates a safety stock quantity from the two occurrence probabilities calculated; and order quantity calculation means which calculates an order quantity of each product, from a stock quantity anticipated at a time point of delivery, the predicted demand quantity during the covered time slot, and the safety stock quantity.

An order quantity calculation method according to the present invention includes: calculating an error in a demand quantity predicted by a prediction model, the prediction model predicting demand quantities of products, on the basis of a difference between a predicted demand quantity calculated using the prediction model and past result data that was not used in learning of the prediction model; from a predicted demand quantity during a covered time slot representing a delivery interval and a predicted demand quantity during a sales permitted period representing a period until abandonment, which are calculated for each product using the prediction model, calculating an error in the predicted demand quantity during the covered time slot and an error in the predicted demand quantity during the sales permitted period; calculating an occurrence probability of the predicted demand quantity during the covered time slot, for each product, from the error in the predicted demand quantity during the covered time slot; calculating an occurrence probability of the predicted demand quantity during the sales permitted period, for each product, from the error in the predicted demand quantity during the sales permitted period; calculating a safety stock quantity from the two occurrence probabilities calculated; and calculating an order quantity of each product, from a stock quantity anticipated at a time point of delivery, the predicted demand quantity during the covered time slot, and the safety stock quantity.

An order quantity determination program according to the present invention causes a computer to perform: error calculation processing of calculating an error in a demand quantity predicted by a prediction model, the prediction model predicting demand quantities of products, on the basis of a difference between a predicted demand quantity calculated using the prediction model and past result data that was not used in learning of the prediction model, and, from a predicted demand quantity during a covered time slot representing a delivery interval and a predicted demand quantity during a sales permitted period representing a period until abandonment, which are calculated for each product using the prediction model, calculating an error in the predicted demand quantity during the covered time slot and an error in the predicted demand quantity during the sales permitted period; safety stock quantity calculation processing of calculating an occurrence probability of the predicted demand quantity during the covered time slot, for each product, from the error in the predicted demand quantity during the covered time slot, calculating an occurrence probability of the predicted demand quantity during the sales permitted period, for each product, from the error in the predicted demand quantity during the sales permitted period, and calculating a safety stock quantity from the two occurrence probabilities calculated; and order quantity calculation processing of calculating an order quantity of each product, from a stock quantity anticipated at a time point of delivery, the predicted demand quantity during the covered time slot, and the safety stock quantity.

### Advantageous Effects of Invention

According to the present invention, it is possible to determine the order quantity in such a way as to reduce both the opportunity loss and the abandonment loss.

### BRIEF DESCRIPTION OF DRAWINGS

FIG. 1 is a block diagram showing an embodiment of an order quantity determination system according to the present invention.

FIG. 2 is a diagram illustrating a relationship between the order quantity and other factors.

FIG. 3 is a diagram illustrating, by way of example, a predicted demand quantity during a covered time slot.

FIG. 4 is a diagram illustrating, by way of example, a predicted demand quantity during a sales permitted period.

FIG. 5 is a diagram illustrating an exemplary normal distribution created.

FIG. 6 is a diagram illustrating another exemplary normal distribution created.

FIG. 7 is a diagram illustrating an exemplary method of calculating a safety stock quantity.

FIG. 8 is a diagram illustrating another exemplary method of calculating a safety stock quantity.

FIG. 9 is a diagram illustrating an exemplary operation of the order quantity determination system.

FIG. 10 is a block diagram giving an overview of the order quantity determination system according to the present invention.

### DESCRIPTION OF EMBODIMENT

An embodiment of the present invention will be described below with reference to the drawings.

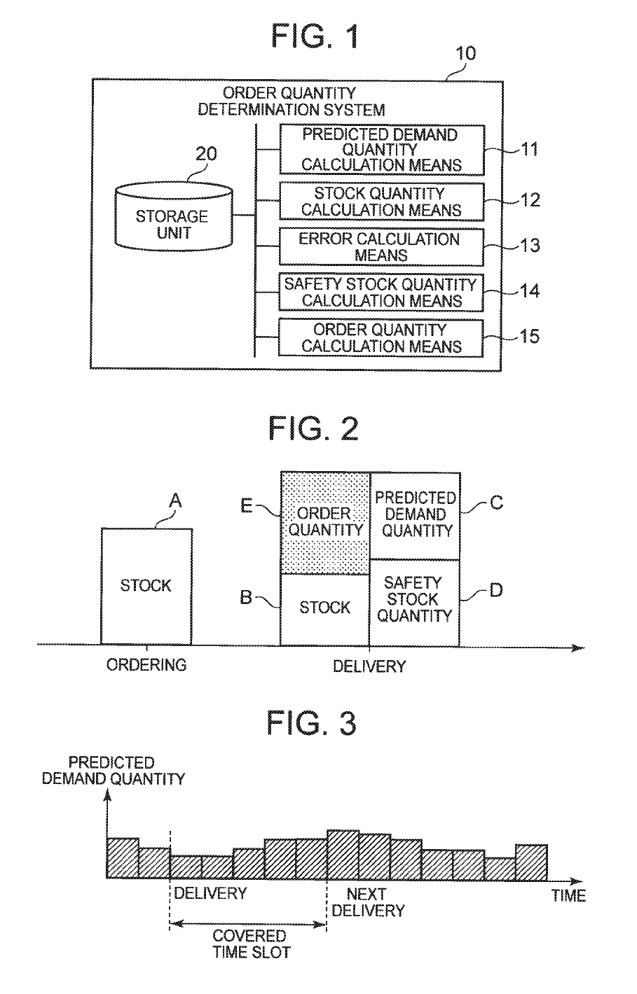

FIG. 1 is a block diagram showing an embodiment of the order quantity determination system according to the present invention. The order quantity determination system 10 of the present embodiment includes predicted demand quantity calculation means 11, stock quantity calculation means 12, error calculation means 13, safety stock quantity calculation means 14, order quantity calculation means 15, and a storage unit 20.

A method for calculating the order quantity in the present invention will be outlined first. FIG. 2 is a diagram illustrating a relationship between the order quantity and other factors. A stock A illustrated in FIG. 2 represents the stock quantity at the time point of ordering, and a stock B represents the stock quantity at the time point of delivery of the product ordered at the time point when there is the stock A. An order quantity E is the order quantity to be calculated in the present embodiment.

In the present embodiment, the order quantity E is determined at the time point of ordering, taking account of the stock B anticipated at the time point of delivery as well as a predicted demand quantity C from the ordering until the delivery and a safety stock quantity D for absorbing variability of the demand prediction.

The storage unit 20 stores masters for use in various processing, past result data on product sales and the like, a prediction model for use in prediction, and others. The storage unit 20 is implemented by, for example, a magnetic disk.

The predicted demand quantity calculation means 11 calculates a predicted demand quantity for each product. The predicted demand quantity calculation means 11 in the present embodiment calculates a predicted demand quantity during a covered time slot and a predicted demand quantity during a sales permitted period for each product.

The covered time slot refers to a period from a time point of delivery to a time point of next delivery, or, a delivery interval. The sales permitted period refers to a period from when a product is delivered until when the product is abandoned, or, a period in which the product is available for sale. In the example shown in FIG. 2, the predicted demand quantity during the covered time slot corresponds to the predicted demand quantity C.

Specifically, the predicted demand quantity calculation means 11 uses a prediction model which predicts demand quantities, to calculate the respective predicted demand quantities. The prediction model used is, for example, a prediction model that predicts a demand quantity on a product category basis (predicted category-wise demand quantity) by day. In this case, the predicted demand quantity calculation means 11 firstly adds up the latest sales results in a category unit, and calculates a sales composition ratio by hour of day. Then, the predicted demand quantity calculation means 11 may multiply the daily predicted result by the calculated sales composition ratio as an hourly distribution rate, to calculate the predicted category-wise demand quantity by hour.

In this case, the predicted demand quantity calculation means 11 further calculates a predicted demand quantity of each single product, from the predicted category-wise demand quantity calculated by hour. For example, the predicted demand quantity calculation means 11 may proportionally distribute the predicted category-wise demand quantity on the basis of the past sales results (sales composition ratios) of the products, to calculate the predicted demand quantity for each single product. Moreover, in order to increase the accuracy of the predicted demand quantity for each single product, the predicted demand quantity calculation means 11 may set only the product(s) for which there remains a stock at the time point of ordering, as the target(s) of distribution.

The description has been given in the present embodiment of the case where the predicted demand quantity calculation means 11 calculates a predicted demand quantity for each single product from the predicted category-wise demand quantity calculated by hour. Alternatively, the safety stock quantity calculation means 14 (described later) may calculate the predicted demand quantity for each single product.

When the predicted demand quantity during the covered time slot and the predicted demand quantity during the sales permitted period have already been calculated for each product, the order quantity determination system 10 does not need to have the predicted demand quantity calculation means 11. In this case, the predicted demand quantity during the covered time slot and the predicted demand quantity during the sales permitted period may be stored in the storage unit 20, for example.

The stock quantity calculation means 12 calculates a stock quantity anticipated at the time point of delivery. In the example shown in FIG. 2, the stock quantity at the time point of delivery corresponds to the stock B. For example, the stock quantity calculation means 12 may add a scheduled delivery quantity during a period from the current time point of ordering to the time when the ordered pieces are delivered, to the stock quantity (the stock A in FIG. 2) at the time point of ordering, and further subtract therefrom the predicted demand quantity during that period, to calculate the stock quantity at the time point of delivery. The stock quantity calculation means 12 may further subtract, from the stock quantity, the number of pieces of product that are to be abandoned during the period from the ordering to the delivery.

The stock quantity calculation means 12 may acquire the scheduled delivery quantity from, for example, a master in the storage unit 20 that stores the quantities already ordered. Further, the stock quantity calculation means 12 may use a prediction engine that predicts a total number of sales of the product in a day, to calculate the predicted demand quantity from the ratio of the time from the ordering to the delivery.

It should be noted that the stock quantity calculation means 12 may calculate the stock quantity at the time point of ordering, from the actual sales quantity and the actual delivery quantity from a certain time point (for example, midnight) the stock quantity at which can be confirmed. Such computation can eliminate the need to actually count the number of pieces in stock.

The error calculation means 13 calculates an error in the demand quantity predicted by a prediction model. Specifically, the error calculation means 13 calculates an error in the prediction model by day, from the predicted demand quantity during the covered time slot and the predicted demand quantity during the sales permitted period calculated for each product. Here, the target prediction model is a prediction model that predicts the demand quantity on a product basis or on a product category basis, which is for example the prediction model used by the predicted demand quantity calculation means 11 to predict the demand quantities. In the case where the order quantity determination system does not include the predicted demand quantity calculation means 11, this prediction model is the one used to derive the predicted demand quantity during the covered time slot and the predicted demand quantity during the sales permitted period.

In the present embodiment, the error calculation means 13 does not calculate the error by comparing the actual demand quantity and the predicted demand quantity as described in PTL 1, for example; it calculates the error in the demand quantity on the basis of the past result data that is available at the time point when a prediction model is generated.

Specifically, the past result data is divided into a learning section and a determination section, and the data in the learning section is used to generate a prediction model. Thereafter, the data in the determination section is used to verify the accuracy (validity) of the prediction model. The error calculation means 13 uses the verified accuracy (i.e. an error rate representing the discrepancy between the predicted result based on the data in the determination section and the actual result) as the accuracy of the prediction model. In this manner, the error calculation means 13 in the present embodiment calculates the error by using a part of the past result data, existing at the time of learning of the prediction model, that was not used in the learning of the prediction model.

Firstly, the error calculation means 13 uses the data in the determination section to calculate an error rate by day. The error rate is calculated, for example, by the following Expression 1. It should be noted that the error calculation means 13 may exclude the data for the day on which sales result (+opportunity loss) was “0” from the target of computation. Further, when it is possible to obtain the opportunity loss, the error calculation means 13 may utilize the value obtained by adding the opportunity loss to the sales result.

Error rate=(predicted demand quantity in the determination section−sales result (+opportunity loss) in the determination section)/sales result (+opportunity loss) in the determination section (Expression 1)

The error calculation means 13 calculates an average of the error rates calculated by day. That is, the error calculation means 13 calculates the error rate on average of the predicted demands for each category. The error rate average is calculated, for example, by the following Expression 2.

Error rate average=(Σ error rate)/the number of days in the determination section (Expression 2)

Further, the error calculation means 13 calculates a standard deviation of the error rate. That is, the error calculation means 13 calculates the degree of dispersion of the predicted demand quantity from the average. The error rate standard deviation is calculated, for example, by the following Expression 3.

Error rate standard deviation=(Σ(sales result (+opportunity loss) in the determination section−error rate average)/the number of days in the determination section ̂1/2) (Expression 3)

It should be noted that the error rate average and the error rate standard deviation are indices concerning a prediction model, so they are calculated at the time of updating the prediction model.

Next, the error calculation means 13 calculates an error in the predicted demand quantity during the covered time slot, on the basis of the calculated error rate average and error rate standard deviation of the prediction model. Specifically, the error calculation means 13 calculates a predicted demand quantity average and a predicted demand quantity standard deviation during the covered time slot.

FIG. 3 illustrates, by way of example, the predicted demand quantity during the covered time slot. In the example shown in FIG. 3, the predicted demand quantity is calculated by hour. In this case, the period from the delivery to the next delivery corresponds to the covered time slot, so a total sum of the predicted demand quantities in this period indicates the predicted demand quantity during the covered time slot.

The predicted demand quantity average σ₁ during the covered time slot is calculated, for example, by the following Expression 4, and the predicted demand quantity standard deviation μ₁ is calculated, for example, by the following Expression 5.

Predicted demand quantity average (σ₁) during the covered time slot=predicted demand quantity during the covered time slot+predicted demand quantity during the covered time slot×error rate average (Expression 4)

Predicted demand quantity standard deviation (μ₁) during the covered time slot=predicted demand quantity average during the covered time slot×error rate standard deviation (Expression 5)

For example, assume that the error rate average=−5%, the error rate standard deviation=0.24, and the predicted demand quantity during the covered time slot is 40. In this case, the calculations are as follows:

Predicted demand quantity average (σ₁) during the covered time slot=40+40×(−5/100)=38

Predicted demand quantity standard deviation (μ₁) during the covered time slot=38×0.24=9.2

Similarly, the error calculation means 13 calculates an error in the predicted demand quantity during the sales permitted period, on the basis of the calculated error rate average and error rate standard deviation of the prediction model. Specifically, the error calculation means 13 calculates a predicted demand quantity average and a predicted demand quantity standard deviation during the sales permitted period.

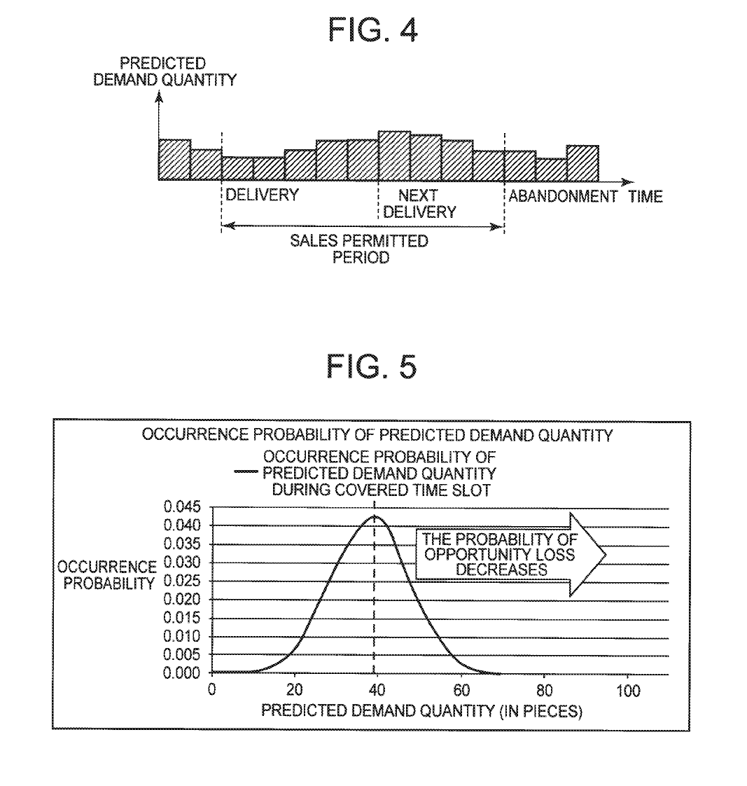

FIG. 4 illustrates, by way of example, the predicted demand quantity during the sales permitted period. In the example shown in FIG. 4 as well, similarly as in FIG. 3, the predicted demand quantity is calculated by hour. In this case, the period from delivery to abandonment corresponds to the sales permitted period, so a total sum of the predicted demand quantities in this period indicates the predicted demand quantity during the sales permitted period.

The predicted demand quantity average σ₂ during the sales permitted period is calculated, for example, by the following Expression 6, and the predicted demand quantity standard deviation μ₂ is calculated, for example, by the following Expression 7.

Predicted demand quantity average (σ₂) during the sales permitted period=predicted demand quantity during the sales permitted period+predicted demand quantity during the sales permitted period×error rate average (Expression 6)

Predicted demand quantity standard deviation (μ₂) during the sales permitted period=predicted demand quantity average during the sales permitted period×error rate standard deviation (Expression 7)

For example, assume that the error rate average=−5%, the error rate standard deviation=0.24, and the predicted demand quantity during the sales permitted period is 60. In this case, the calculations are as follows:

Predicted demand quantity average (σ₂) during the sales permitted period=60+60×(−5/100)=57

Predicted demand quantity standard deviation (μ₂) during the sales permitted period=57×0.24=13.8

The safety stock quantity calculation means 14 uses the calculated error by day to calculate the safety stock quantity for each product. In the example shown in FIG. 2, the safety stock quantity to be calculated corresponds to the predicted demand quantity D. As explained before, the safety stock quantity is a stock quantity for absorbing the variability of the demand prediction; it can be said to be a stock quantity that is held so as not to cause abandonment or stockout. Further, for the predicted demand quantity described later, the predicted demand quantity of each product by hour calculated by the predicted demand quantity calculation means 11, for example, is used.

Firstly, the safety stock quantity calculation means 14 calculates an occurrence probability of the predicted demand quantity during the covered time slot, from the predicted demand quantity average and the predicted demand quantity standard deviation during the covered time slot. Specifically, the safety stock quantity calculation means 14 creates a normal distribution indicating the occurrence probability for each product, from the predicted demand quantity average and the predicted demand quantity standard deviation during the covered time slot. FIG. 5 illustrates an example of the normal distribution created. The example shown in FIG. 5 indicates a normal distribution with the average of 38 and the standard deviation of 9.2 as in the specific example described above.

For example, even when the predicted demand quantity during the covered time slot is 40, there is a probability that the product sells 40 or more pieces (specifically, the portion to the right of the broken line in FIG. 5). Thus, when the order is placed only taking account of the predicted demand quantity during the covered time slot, the possibility of occurrence of stockout (i.e. opportunity loss) will increase.

Taking account of the safety stock quantity to address such variability of the demand leads to a decreased height of the curve illustrated in FIG. 5 (i.e. the occurrence probability) and, hence, a reduced probability of occurrence of stockout.

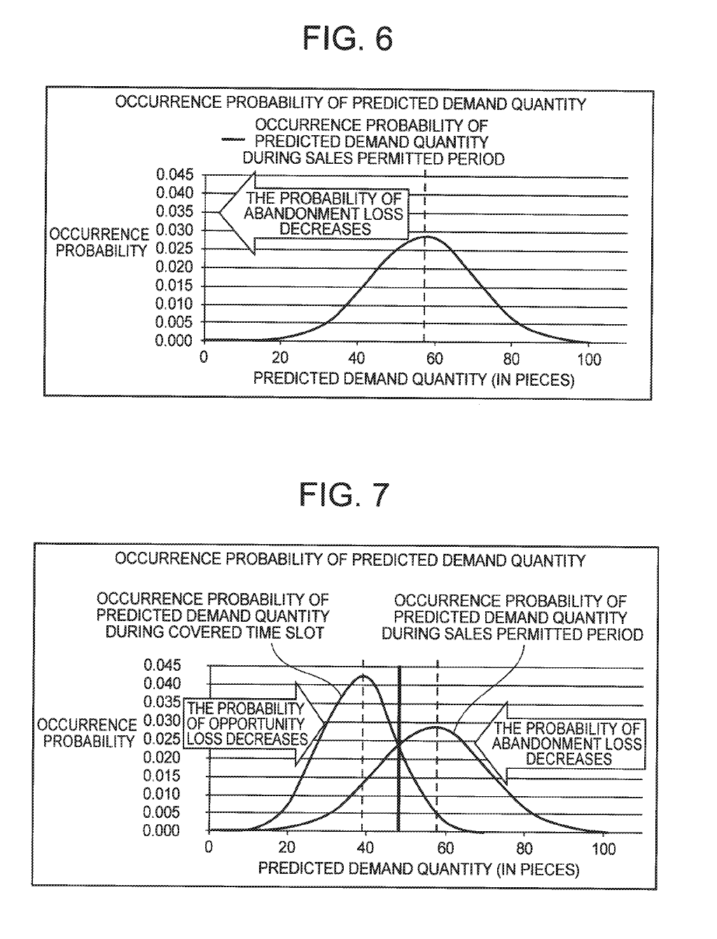

Similarly, the safety stock quantity calculation means 14 calculates an occurrence probability of the predicted demand quantity during the sales permitted period, from the predicted demand quantity average and the predicted demand quantity standard deviation during the sales permitted period. Specifically, the safety stock quantity calculation means 14 creates a normal distribution indicating the occurrence probability for each product, from the predicted demand quantity average and the predicted demand quantity standard deviation during the sales permitted period. FIG. 6 illustrates another example of the normal distribution created. The example shown in FIG. 6 indicates a normal distribution with the average of 57 and the standard deviation of 13.8 as in the specific example described above.

As in the case of the prediction for the covered time slot, even when the predicted demand quantity during the sales permitted period is 60, there is a probability that the product sells only 60 pieces or less (specifically, the portion to the left of the broken line in FIG. 6). Thus, when the stock quantity is increased to the predicted demand quantity during the sales permitted period, the possibility of occurrence of abandonment will increase.

Taking account of the safety stock quantity to address such variability of the demand as well leads to a decreased height of the curve illustrated in FIG. 6 (i.e. the occurrence probability) and, hence, a reduced probability of occurrence of abandonment.

It should be noted that, as different products have different sales permitted periods, the safety stock quantity calculation means 14 calculates the occurrence probability of the predicted demand quantity during the sales permitted period for each product. The safety stock quantity calculation means 14 thus calculates the occurrence probability of the predicted demand quantity during the covered time slot and the occurrence probability of the predicted demand quantity during the sales permitted period, for each product, from the calculated error by day.

As explained before, if the probability of occurrence of stockout and the probability of occurrence of abandonment can both be lowered, the opportunity loss and the abandonment loss can both be decreased. Thus, the safety stock quantity calculation means 14 calculates an appropriate safety stock quantity on the basis of the two calculated occurrence probabilities (the occurrence probability of the predicted demand quantity during the covered time slot and the occurrence probability of the predicted demand quantity during the sales permitted period).

A description will be given of specific methods of calculating the safety stock quantity on the basis of the two occurrence probabilities. The first method of calculating the safety stock quantity uses the predicted demand quantity at the point of intersection of two normal distributions as the predicted demand quantity to be added to the stock quantity. FIG. 7 illustrates an example of the method of calculating the safety stock quantity. In the example shown in FIG. 7, the normal distribution on the left in the graph represents the occurrence probability of the predicted demand quantity during the covered time slot, and the normal distribution on the right in the graph represents the occurrence probability of the predicted demand quantity during the sales permitted period.

The point of intersection of these two normal distributions can be calculated by the following Expression 8. In the Expression 8, “x” represents [predicted demand quantity+safety stock quantity] during the covered time slot.

$$\begin{matrix} [ Math . 1 ] & \\ \frac{1}{2 {πσ}_{1}^{2}} exp ( - \frac{{( x - {μ}_{1} )}^{2}}{2 {σ}_{1}^{2}} ) = \frac{1}{\sqrt{2 {πσ}_{2}^{2}}} exp ( - \frac{{( x - {μ}_{2} )}^{2}}{2 {σ}_{2}^{2}} ) & ( Expression 8 )\end{matrix}$$

An expected value of the opportunity loss and that of the abandonment loss are each calculated as a sum of products of the predicted demand quantity and the occurrence probability. In other words, the sum of products of the predicted demand quantity and the occurrence probability represents the integral (area) of the normal distribution corresponding to the range of the predicted demand quantity.

When the point of intersection of the two normal distributions is used for calculation of the safety stock quantity, it is possible to minimize the sum of the expected values of the opportunity loss and the abandonment loss (i.e. the sum of the areas of the two), although the expected values of the opportunity loss and the abandonment loss differ in magnitude from each other. In this manner, the safety stock quantity calculation means 14 may calculate the safety stock quantity so as to minimize the sum of the expected values of the opportunity loss and the abandonment loss.

Specifically, the safety stock quantity is calculated as a difference between the predicted demand quantity at the point of intersection and the predicted demand quantity during the covered time slot (safety stock quantity=predicted demand quantity at the point of intersection−predicted demand quantity during the covered time slot). For example, assume that the calculation result of x=48 is obtained in the example shown in FIG. 7. In this case, the safety stock quantity calculation means 14 subtracts the predicted demand quantity “40” during the covered time slot from the predicted demand quantity “48” at the point of intersection to calculate the safety stock quantity as “8”.

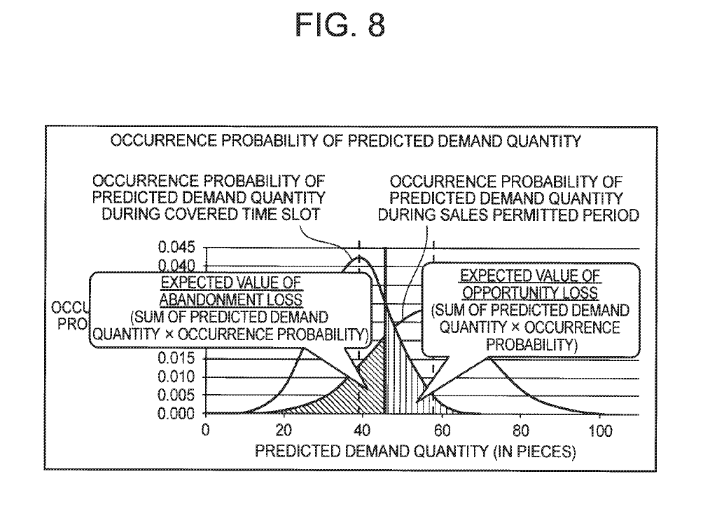

The second method of calculating the safety stock quantity uses a predicted demand quantity for which the two expected values become equal in magnitude to each other as the predicted demand quantity to be added to the stock quantity. FIG. 8 illustrates an example of the other method of calculating the safety stock quantity. In the example shown in FIG. 8 as well, similarly as in the example shown in FIG. 7, the normal distribution on the left in the graph represents the occurrence probability of the predicted demand quantity during the covered time slot, and the normal distribution on the right in the graph represents the occurrence probability of the predicted demand quantity during the sales permitted period.

Further, the vertical bold line illustrated in FIG. 8 represents the predicted demand quantity during the covered time slot+safety stock quantity. The area of the right side portion delimited by this predicted demand quantity during the covered time slot+safety stock quantity and the graph of the normal distribution of the predicted demand quantity during the covered time slot represents the expected value of the opportunity loss, which is calculated as a sum of the products of the predicted demand quantity and the occurrence probability. Similarly, the area of the left side portion delimited by the predicted demand quantity during the covered time slot+safety stock quantity and the graph of the normal distribution of the predicted demand quantity during the sales permitted period represents the expected value of the abandonment loss, which is calculated as a sum of the products of the predicted demand quantity and the occurrence probability.

The predicted demand quantity for which the two expected values become equal in magnitude can be calculated by the following Expression 9. In the Expression 9 as well, “x” represents [predicted demand quantity+safety stock quantity] during the covered time slot.

$$\begin{matrix} [ Math . 2 ] & \\ \int \frac{1}{\sqrt{2 {πσ}_{1}^{2}}} exp ( - \frac{{( x - {μ}_{1} )}^{2}}{2 {σ}_{1}^{2}} ) = \int \frac{1}{\sqrt{2 {πσ}_{2}^{2}}} exp ( - \frac{{( x - {μ}_{2} )}^{2}}{2 {σ}_{2}^{2}} ) & ( Expression 9 )\end{matrix}$$

When the predicted demand quantity for which the two expected values become equal in magnitude is used for calculation of the safety stock quantity, it is possible to make the magnitudes of the expected values of the opportunity loss and the abandonment loss equal to each other, although the sum of the expected values of the opportunity loss and the abandonment loss (i.e. the sum of the two areas) is not minimized. In this manner, the safety stock quantity calculation means 14 may calculate the safety stock quantity so as to make the expected values of the opportunity loss and the abandonment loss equal to each other. As in the first method, the safety stock quantity is calculated as follows: safety stock quantity=predicted demand quantity at the point of intersection−predicted demand quantity during the covered time slot.

Which one of the first and second methods to use for calculating the safety stock quantity may be determined in advance in accordance with the product category, user intention, and the like. Further, the safety stock quantity calculation means 14 may adjust the safety stock quantity by multiplying the safety stock quantity by a preset adjustment rate in preparation for abrupt change in sales quantity.

The order quantity calculation means 15 calculates an order quantity for each product, from a stock quantity anticipated at the time point of delivery, the predicted demand quantity during the covered time slot, and the safety stock quantity. Specifically, the order quantity calculation means 15 may add up the stock quantity anticipated at the time point of delivery and the safety stock quantity and subtract therefrom the stock quantity anticipated at the time point of delivery, to obtain the resultant value as the order quantity. In the example shown in FIG. 2, the order quantity calculated corresponds to the order quantity E.

The predicted demand quantity calculation means 11, the stock quantity calculation means 12, the error calculation means 13, the safety stock quantity calculation means 14, and the order quantity calculation means 15 are implemented by the CPU of a computer that operates in accordance with a program (order quantity determination program). For example, the program may be stored in the storage unit 20, and the CPU may read the program and operate as the predicted demand quantity calculation means 11, the stock quantity calculation means 12, the error calculation means 13, the safety stock quantity calculation means 14, and the order quantity calculation means 15 in accordance with the program.

Alternatively, the predicted demand quantity calculation means 11, the stock quantity calculation means 12, the error calculation means 13, the safety stock quantity calculation means 14, and the order quantity calculation means 15 may each be implemented by dedicated hardware. Still alternatively, the order quantity determination system according to the present invention may be constituted by two or more physically separate devices connected in a wired or wireless manner.

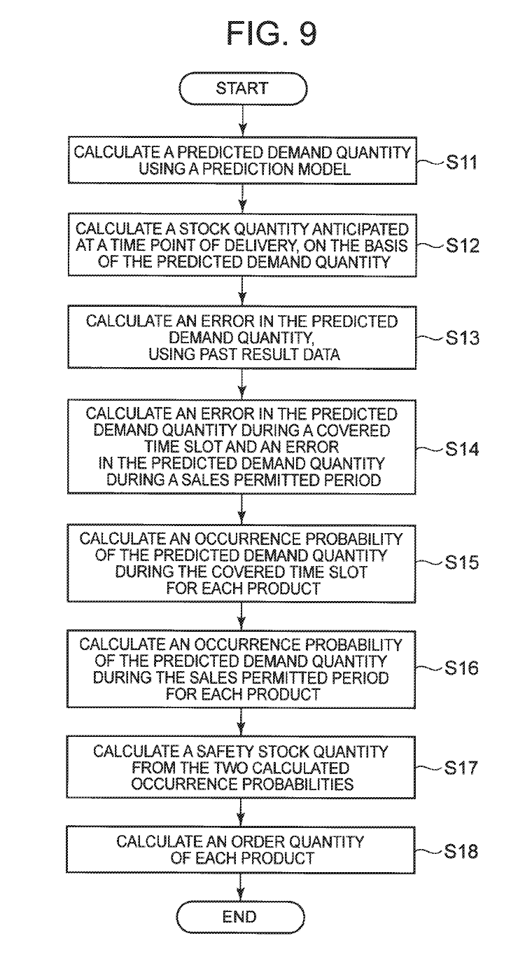

A description will now be given of the operation of the order quantity determination system in the present embodiment. FIG. 9 illustrates an exemplary operation of the order quantity determination system in the present embodiment. Firstly, the predicted demand quantity calculation means 11 calculates a predicted demand quantity using a prediction model (step S11). The stock quantity calculation means 12 calculates a stock quantity anticipated at the time point of delivery, on the basis of the predicted demand quantity (step S12).

The error calculation means 13 uses past result data to calculate an error in the demand quantity predicted by the prediction model (step S13). Specifically, the error calculation means 13 calculates an error rate average and an error rate standard deviation of the prediction model as the errors in the prediction model. Next, the error calculation means 13 calculates, from a predicted demand quantity during a covered time slot and a predicted demand quantity during a sales permitted period, an error in the predicted demand quantity during the covered time slot and an error in the predicted demand quantity during the sales permitted period (step S14). Specifically, the error calculation means 13 calculates a predicted demand quantity average and a predicted demand quantity standard deviation for each of the covered time slot and the sales permitted period.

The safety stock quantity calculation means 14 calculates an occurrence probability of the predicted demand quantity during the covered time slot, for each product, from the error in the predicted demand quantity during the covered time slot (step S15). The safety stock quantity calculation means 14 further calculates an occurrence probability of the predicted demand quantity during the sales permitted period, for each product, from the error in the predicted demand quantity during the sales permitted period (step S16). The safety stock quantity calculation means 14 then calculates a safety stock quantity from the two calculated occurrence probabilities (step S17).

The order quantity calculation means 15 calculates an order quantity for each product, from a stock quantity anticipated at the time point of delivery, the predicted demand quantity during the covered time slot, and the safety stock quantity (step S18).

As described above, in the present embodiment, the error calculation means 13 calculates an error in the demand quantity predicted by a prediction model, on the basis of a difference between the predicted demand quantity calculated using the prediction model and the past result data that was not used in learning of the prediction model. Further, from the predicted demand quantity during the covered time slot and the predicted demand quantity during the sales permitted period calculated for each product using the prediction model, the error calculation means 13 calculates an error in the predicted demand quantity during the covered time slot and an error in the predicted demand quantity during the sales permitted period. The safety stock quantity calculation means 14 calculates an occurrence probability of the predicted demand quantity during the covered time slot, for each product, from the error in the predicted demand quantity during the covered time slot, calculates an occurrence probability of the predicted demand quantity during the sales permitted period, for each product, from the error in the predicted demand quantity during the sales permitted period, and calculates a safety stock quantity from the two calculated occurrence probabilities. Then, the order quantity calculation means 15 calculates an order quantity for each product, from a stock quantity anticipated at the time point of delivery, the predicted demand quantity during the covered time slot, and the safety stock quantity. It is thus possible to determine the order quantity in such a way as to reduce both the opportunity loss and the abandonment loss.

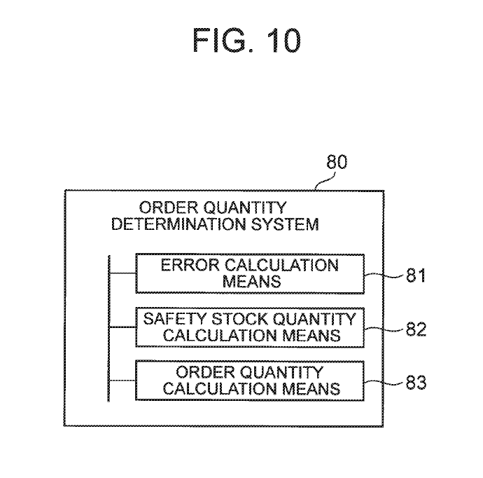

The present invention will now be outlined. FIG. 10 is a block diagram giving an overview of the order quantity determination system according to the present invention. The order quantity determination system 80 according to the present invention includes: error calculation means 81 (for example, error calculation means 13) which calculates, on the basis of a difference between a predicted demand quantity (for example, predicted demand quantity by day for each product) calculated using a prediction model that predicts product demand quantities and past result data (for example, data in a determination section) that was not used in learning of the prediction model, an error in (for example, error rate of) a demand quantity predicted by the prediction model, and calculates, from a predicted demand quantity during a covered time slot, representing a delivery interval, and a predicted demand quantity during a sales permitted period, representing a period until abandonment, which are calculated for each product using the prediction model, an error in the predicted demand quantity during the covered time slot and an error in the predicted demand quantity during the sales permitted period; safety stock quantity calculation means 82 (for example, safety stock quantity calculation means 14) which calculates an occurrence probability of the predicted demand quantity during the covered time slot for each product, from the error in the predicted demand quantity during the covered time slot, calculates an occurrence probability of the predicted demand quantity during the sales permitted period for each product, from the error in the predicted demand quantity during the sales permitted period, and calculates a safety stock quantity from the two occurrence probabilities calculated; and order quantity calculation means 83 (for example, order quantity calculation means 15) which calculates an order quantity of each product, from a stock quantity anticipated at a time point of delivery, the predicted demand quantity during the covered time slot, and the safety stock quantity.

With this configuration, it is possible to determine the order quantity in such a way as to reduce both the opportunity loss and the abandonment loss.

Further, the safety stock quantity calculation means 82 may calculate an expected value of opportunity loss, which is a sum of multiplications of any predicted demand quantity not less than a quantity obtained by summing the predicted demand quantity during the covered time slot and the safety stock quantity by the occurrence probability of that predicted demand quantity, and an expected value of abandonment loss, which is a sum of multiplications of any predicted demand quantity not more than a quantity obtained by summing the predicted demand quantity during the sales permitted period and the safety stock quantity by the occurrence probability of that predicted demand quantity, and calculate the safety stock quantity by using a predicted demand quantity for which the expected value of the opportunity loss and the expected value of the abandonment loss coincide with each other.

With this configuration, the occurrence probabilities of the opportunity loss and the abandonment loss can be made equal to each other, and accordingly, the probabilities of occurrence of the losses themselves can be restricted low.

Alternatively, the safety stock quantity calculation means 82 may calculate the safety stock quantity by using a predicted demand quantity for which the occurrence probability of the predicted demand quantity during the covered time slot and the occurrence probability of the predicted demand quantity during the sales permitted period coincide with each other.

With this configuration, the sum of the expected values of the opportunity loss and the abandonment loss can be minimized, and accordingly, the losses that may occur can be restricted low.

Further, the error calculation means 81 may calculate an error rate average and an error rate standard deviation of the prediction model as errors of that prediction model, and calculate the errors in the predicted demand quantities during the covered time slot and during the sales permitted period on the basis of the error rate average and the error rate standard deviation calculated.

At this time, the error calculation means 81 may calculate a predicted demand quantity average and a predicted demand quantity standard deviation for each of the covered time slot and the sales permitted period, on the basis of the error rate average and the error rate standard deviation of the prediction model.

Then, the safety stock quantity calculation means 82 may create, for each product, normal distributions indicating the occurrence probabilities of the predicted demand quantities during the covered time slot and during the sales permitted period, from the predicted demand quantity averages and the predicted demand quantity standard deviations during the covered time slot and during the sales permitted period.

The order quantity determination system 80 may further include predicted demand quantity calculation means (for example, predicted demand quantity calculation means 11) which calculates a predicted demand quantity by day for each category, by using a prediction model that predicts, by day, a predicted category-wise demand quantity which is a demand quantity on a product category basis. The predicted demand quantity calculation means may proportionally distribute the predicted category-wise demand quantity on the basis of a past sales composition ratio and an hourly sales composition ratio of each product, to calculate a predicted demand quantity of each single product by hour. The error calculation means 81 may calculate, from the predicted demand quantity of each single product calculated by hour, corresponding predicted demand quantities during the covered time slot and during the sales permitted period.

The order quantity determination system 80 may further include stock quantity calculation means (for example, stock quantity calculation means 12) which calculates the stock quantity anticipated at the time point of delivery, from a stock quantity at a time point of ordering.

A part of or all of the above embodiment may also be described as, but not limited to, the following appendices.

(Supplementary note 1) An order quantity determination system comprising: error calculation means which calculates an error in a demand quantity predicted by a prediction model, the prediction model predicting demand quantities of products, on the basis of a difference between a predicted demand quantity calculated using the prediction model and past result data that was not used in learning of the prediction model, and, from a predicted demand quantity during a covered time slot representing a delivery interval and a predicted demand quantity during a sales permitted period representing a period until abandonment, which are calculated for each product using the prediction model, calculates an error in the predicted demand quantity during the covered time slot and an error in the predicted demand quantity during the sales permitted period; safety stock quantity calculation means which calculates an occurrence probability of the predicted demand quantity during the covered time slot, for each product, from the error in the predicted demand quantity during the covered time slot, calculates an occurrence probability of the predicted demand quantity during the sales permitted period, for each product, from the error in the predicted demand quantity during the sales permitted period, and calculates a safety stock quantity from the two occurrence probabilities calculated; and order quantity calculation means which calculates an order quantity of each product, from a stock quantity anticipated at a time point of delivery, the predicted demand quantity during the covered time slot, and the safety stock quantity.

(Supplementary note 2) The order quantity determination system according to Supplementary note 1, wherein the safety stock quantity calculation means calculates an expected value of opportunity loss which is a sum of multiplications of any predicted demand quantity not less than a quantity obtained by summing the predicted demand quantity during the covered time slot and the safety stock quantity by the occurrence probability of that predicted demand quantity, and an expected value of abandonment loss which is a sum of multiplications of any predicted demand quantity not more than a quantity obtained by summing the predicted demand quantity during the sales permitted period and the safety stock quantity by the occurrence probability of that predicted demand quantity, and calculates the safety stock quantity by using a predicted demand quantity for which the expected value of the opportunity loss and the expected value of the abandonment loss coincide with each other.

(Supplementary note 3) The order quantity determination system according to Supplementary note 1, wherein the safety stock quantity calculation means calculates the safety stock quantity by using a predicted demand quantity for which the occurrence probability of the predicted demand quantity during the covered time slot and the occurrence probability of the predicted demand quantity during the sales permitted period coincide with each other.

(Supplementary note 4) The order quantity determination system according to any one of Appendices 1 to 3, wherein the error calculation means calculates an error rate average and an error rate standard deviation of the prediction model as errors of the prediction model, and calculates each of the errors in the predicted demand quantities during the covered time slot and during the sales permitted period on the basis of the error rate average and the error rate standard deviation calculated.

(Supplementary note 5) The order quantity determination system according to Supplementary note 4, wherein the error calculation means calculates a predicted demand quantity average and a predicted demand quantity standard deviation for each of the covered time slot and the sales permitted period, on the basis of the error rate average and the error rate standard deviation of the prediction model.

(Supplementary note 6) The order quantity determination system according to Supplementary note 5, wherein the safety stock quantity calculation means creates, for each product, normal distributions indicating the occurrence probabilities of the predicted demand quantities during the covered time slot and during the sales permitted period, from the predicted demand quantity averages and the predicted demand quantity standard deviations during the covered time slot and during the sales permitted period.

(Supplementary note 7) The order quantity determination system according to any one of Appendices 1 to 6, comprising: predicted demand quantity calculation means which calculates a predicted demand quantity by day for each category by using a prediction model that predicts by day a predicted category-wise demand quantity which is a demand quantity on a product category basis, wherein the predicted demand quantity calculation means proportionally distributes the predicted category-wise demand quantity on the basis of a past sales composition ratio and an hourly sales composition ratio of each product, to calculate a predicted demand quantity of each single product by hour, and the error calculation means calculates, from the predicted demand quantity of each single product calculated by hour, corresponding predicted demand quantities during the covered time slot and during the sales permitted period.

(Supplementary note 8) The order quantity determination system according to any one of Appendices 1 to 7, comprising: stock quantity calculation means which calculates the stock quantity anticipated at the time point of delivery from a stock quantity at a time point of ordering.

(Supplementary note 9) An order quantity calculation method comprising: calculating an error in a demand quantity predicted by a prediction model, the prediction model predicting demand quantities of products, on the basis of a difference between a predicted demand quantity calculated using the prediction model and past result data that was not used in learning of the prediction model; from a predicted demand quantity during a covered time slot representing a delivery interval and a predicted demand quantity during a sales permitted period representing a period until abandonment, which are calculated for each product using the prediction model, calculating an error in the predicted demand quantity during the covered time slot and an error in the predicted demand quantity during the sales permitted period; calculating an occurrence probability of the predicted demand quantity during the covered time slot, for each product, from the error in the predicted demand quantity during the covered time slot; calculating an occurrence probability of the predicted demand quantity during the sales permitted period, for each product, from the error in the predicted demand quantity during the sales permitted period; calculating a safety stock quantity from the two occurrence probabilities calculated; and calculating an order quantity of each product, from a stock quantity anticipated at a time point of delivery, the predicted demand quantity during the covered time slot, and the safety stock quantity.

(Supplementary note 10) The order quantity determination method according to Supplementary note 9, comprising: calculating an expected value of opportunity loss which is a sum of multiplications of any predicted demand quantity not less than a quantity obtained by summing the predicted demand quantity during the covered time slot and the safety stock quantity by the occurrence probability of that predicted demand quantity, and an expected value of abandonment loss which is a sum of multiplications of any predicted demand quantity not more than a quantity obtained by summing the predicted demand quantity during the sales permitted period and the safety stock quantity by the occurrence probability of that predicted demand quantity; and calculating the safety stock quantity by using a predicted demand quantity for which the expected value of the opportunity loss and the expected value of the abandonment loss coincide with each other.

(Supplementary note 11) The order quantity determination method according to Supplementary note 9, comprising: calculating the safety stock quantity by using a predicted demand quantity for which the occurrence probability of the predicted demand quantity during the covered time slot and the occurrence probability of the predicted demand quantity during the sales permitted period coincide with each other.

(Supplementary note 12) An order quantity determination program for causing a computer to perform: error calculation processing of calculating an error in a demand quantity predicted by a prediction model, the prediction model predicting demand quantities of products, on the basis of a difference between a predicted demand quantity calculated using the prediction model and past result data that was not used in learning of the prediction model, and, from a predicted demand quantity during a covered time slot representing a delivery interval and a predicted demand quantity during a sales permitted period representing a period until abandonment, which are calculated for each product using the prediction model, calculating an error in the predicted demand quantity during the covered time slot and an error in the predicted demand quantity during the sales permitted period; safety stock quantity calculation processing of calculating an occurrence probability of the predicted demand quantity during the covered time slot, for each product, from the error in the predicted demand quantity during the covered time slot, calculating an occurrence probability of the predicted demand quantity during the sales permitted period, for each product, from the error in the predicted demand quantity during the sales permitted period, and calculating a safety stock quantity from the two occurrence probabilities calculated; and order quantity calculation processing of calculating an order quantity of each product, from a stock quantity anticipated at a time point of delivery, the predicted demand quantity during the covered time slot, and the safety stock quantity.

(Supplementary note 13) The order quantity determination program according to Supplementary note 12, causing the computer, in the safety stock quantity calculation processing, to calculate an expected value of opportunity loss which is a sum of multiplications of any predicted demand quantity not less than a quantity obtained by summing the predicted demand quantity during the covered time slot and the safety stock quantity by the occurrence probability of that predicted demand quantity, and an expected value of abandonment loss which is a sum of multiplications of any predicted demand quantity not more than a quantity obtained by summing the predicted demand quantity during the sales permitted period and the safety stock quantity by the occurrence probability of that predicted demand quantity, and calculate the safety stock quantity by using a predicted demand quantity for which the expected value of the opportunity loss and the expected value of the abandonment loss coincide with each other.

(Supplementary note 14) The order quantity determination program according to Supplementary note 12, causing the computer, in the safety stock quantity calculation processing, to calculate the safety stock quantity by using a predicted demand quantity for which the occurrence probability of the predicted demand quantity during the covered time slot and the occurrence probability of the predicted demand quantity during the sales permitted period coincide with each other.

While the present invention has been described with reference to the embodiment and examples, the present invention is not limited to the embodiment or examples above. Various modifications understandable by those skilled in the art can be made to the configurations and details of the present invention within the scope of the present invention.

This application claims priority based on Japanese Patent Application No. 2016-172529 filed on Sep. 5, 2016, the disclosure of which is incorporated herein in its entirety.

### REFERENCE SIGNS LIST

10 order quantity determination system

11 predicted demand quantity calculation means

12 stock quantity calculation means

13 error calculation means

14 safety stock quantity calculation means

15 order quantity calculation means

20 storage unit

What is claimed is:

1. An order quantity determination system comprising:
a hardware including a processor;
an error calculation unit, implemented by the processor, which calculates an error in a demand quantity predicted by a prediction model, the prediction model predicting demand quantities of products, on the basis of a difference between a predicted demand quantity calculated using the prediction model and past result data that was not used in learning of the prediction model, and, from a predicted demand quantity during a covered time slot representing a delivery interval and a predicted demand quantity during a sales permitted period representing a period until abandonment, which are calculated for each product using the prediction model, calculates an error in the predicted demand quantity during the covered time slot and an error in the predicted demand quantity during the sales permitted period;
a safety stock quantity calculation unit, implemented by the processor, which calculates an occurrence probability of the predicted demand quantity during the covered time slot, for each product, from the error in the predicted demand quantity during the covered time slot, calculates an occurrence probability of the predicted demand quantity during the sales permitted period, for each product, from the error in the predicted demand quantity during the sales permitted period, and calculates a safety stock quantity from the two occurrence probabilities calculated; and
an order quantity calculation unit, implemented by the processor, which calculates an order quantity of each product, from a stock quantity anticipated at a time point of delivery, the predicted demand quantity during the covered time slot, and the safety stock quantity.

2. The order quantity determination system according to claim 1, wherein the safety stock quantity calculation unit calculates an expected value of opportunity loss which is a sum of multiplications of any predicted demand quantity not less than a quantity obtained by summing the predicted demand quantity during the covered time slot and the safety stock quantity by the occurrence probability of that predicted demand quantity, and an expected value of abandonment loss which is a sum of multiplications of any predicted demand quantity not more than a quantity obtained by summing the predicted demand quantity during the sales permitted period and the safety stock quantity by the occurrence probability of that predicted demand quantity, and calculates the safety stock quantity by using a predicted demand quantity for which the expected value of the opportunity loss and the expected value of the abandonment loss coincide with each other.

3. The order quantity determination system according to claim 1, wherein the safety stock quantity calculation unit calculates the safety stock quantity by using a predicted demand quantity for which the occurrence probability of the predicted demand quantity during the covered time slot and the occurrence probability of the predicted demand quantity during the sales permitted period coincide with each other.

4. The order quantity determination system according to claim 1, wherein the error calculation unit calculates an error rate average and an error rate standard deviation of the prediction model as errors of the prediction model, and calculates each of the errors in the predicted demand quantities during the covered time slot and during the sales permitted period on the basis of the error rate average and the error rate standard deviation calculated.

5. The order quantity determination system according to claim 4, wherein the error calculation unit calculates a predicted demand quantity average and a predicted demand quantity standard deviation for each of the covered time slot and the sales permitted period, on the basis of the error rate average and the error rate standard deviation of the prediction model.

6. The order quantity determination system according to claim 5, wherein the safety stock quantity calculation unit creates, for each product, normal distributions indicating the occurrence probabilities of the predicted demand quantities during the covered time slot and during the sales permitted period, from the predicted demand quantity averages and the predicted demand quantity standard deviations during the covered time slot and during the sales permitted period.

7. The order quantity determination system according to claim 1, comprising:
a predicted demand quantity calculation unit, implemented by the processor, which calculates a predicted demand quantity by day for each category by using a prediction model that predicts by day a predicted category-wise demand quantity which is a demand quantity on a product category basis, wherein
the predicted demand quantity calculation unit proportionally distributes the predicted category-wise demand quantity on the basis of a past sales composition ratio and an hourly sales composition ratio of each product, to calculate a predicted demand quantity of each single product by hour, and
the error calculation unit calculates, from the predicted demand quantity of each single product calculated by hour, corresponding predicted demand quantities during the covered time slot and during the sales permitted period.

8. The order quantity determination system according to claim 1, comprising:
a stock quantity calculation unit, implemented by the processor, which calculates the stock quantity anticipated at the time point of delivery from a stock quantity at a time point of ordering.

9. An order quantity determination method comprising:
calculating an error in a demand quantity predicted by a prediction model, the prediction model predicting demand quantities of products, on the basis of a difference between a predicted demand quantity calculated using the prediction model and past result data that was not used in learning of the prediction model;
from a predicted demand quantity during a covered time slot representing a delivery interval and a predicted demand quantity during a sales permitted period representing a period until abandonment, which are calculated for each product using the prediction model, calculating an error in the predicted demand quantity during the covered time slot and an error in the predicted demand quantity during the sales permitted period;
calculating an occurrence probability of the predicted demand quantity during the covered time slot, for each product, from the error in the predicted demand quantity during the covered time slot;
calculating an occurrence probability of the predicted demand quantity during the sales permitted period, for each product, from the error in the predicted demand quantity during the sales permitted period;
calculating a safety stock quantity from the two occurrence probabilities calculated; and
calculating an order quantity of each product, from a stock quantity anticipated at a time point of delivery, the predicted demand quantity during the covered time slot, and the safety stock quantity.

10. The order quantity determination method according to claim 9, comprising:
calculating an expected value of opportunity loss which is a sum of multiplications of any predicted demand quantity not less than a quantity obtained by summing the predicted demand quantity during the covered time slot and the safety stock quantity by the occurrence probability of that predicted demand quantity, and an expected value of abandonment loss which is a sum of multiplications of any predicted demand quantity not more than a quantity obtained by summing the predicted demand quantity during the sales permitted period and the safety stock quantity by the occurrence probability of that predicted demand quantity; and
calculating the safety stock quantity by using a predicted demand quantity for which the expected value of the opportunity loss and the expected value of the abandonment loss coincide with each other.

11. The order quantity determination method according to claim 9, comprising:
calculating the safety stock quantity by using a predicted demand quantity for which the occurrence probability of the predicted demand quantity during the covered time slot and the occurrence probability of the predicted demand quantity during the sales permitted period coincide with each other.

12. A non-transitory computer readable information recording medium storing an order quantity determination program, when executed by a processor, that performs a method for:
calculating an error in a demand quantity predicted by a prediction model, the prediction model predicting demand quantities of products, on the basis of a difference between a predicted demand quantity calculated using the prediction model and past result data that was not used in learning of the prediction model, and, from a predicted demand quantity during a covered time slot representing a delivery interval and a predicted demand quantity during a sales permitted period representing a period until abandonment, which are calculated for each product using the prediction model, calculating an error in the predicted demand quantity during the covered time slot and an error in the predicted demand quantity during the sales permitted period;
calculating an occurrence probability of the predicted demand quantity during the covered time slot, for each product, from the error in the predicted demand quantity during the covered time slot, calculating an occurrence probability of the predicted demand quantity during the sales permitted period, for each product, from the error in the predicted demand quantity during the sales permitted period, and calculating a safety stock quantity from the two occurrence probabilities calculated; and
calculating an order quantity of each product, from a stock quantity anticipated at a time point of delivery, the predicted demand quantity during the covered time slot, and the safety stock quantity.

13. The non-transitory computer readable information recording medium according to claim 12, comprising: calculating an expected value of opportunity loss which is a sum of multiplications of any predicted demand quantity not less than a quantity obtained by summing the predicted demand quantity during the covered time slot and the safety stock quantity by the occurrence probability of that predicted demand quantity, and an expected value of abandonment loss which is a sum of multiplications of any predicted demand quantity not more than a quantity obtained by summing the predicted demand quantity during the sales permitted period and the safety stock quantity by the occurrence probability of that predicted demand quantity, and
calculating the safety stock quantity by using a predicted demand quantity for which the expected value of the opportunity loss and the expected value of the abandonment loss coincide with each other.

14. The non-transitory computer readable information recording medium according to claim 12, comprising: calculating the safety stock quantity by using a predicted demand quantity for which the occurrence probability of the predicted demand quantity during the covered time slot and the occurrence probability of the predicted demand quantity during the sales permitted period coincide with each other.
